(19) United States
(12) Patent Application Publication
(10) Pub. No.: US 2017/0300531 A1
(43) Pub. Date: Oct. 19, 2017

(54) TAG BASED SEARCHING IN DATA ANALYTICS

(71) Applicant: SAP SE, Walldorf (DE)

(72) Inventors: SUNDER POOVANANATHAN, Bangalore (IN); ANURAG JAIN, Shikohabad (IN)

(21) Appl. No.: 15/099,579

(22) Filed: Apr. 14, 2016

(51) Int. Cl. G06F 17/30

(52) U.S. Cl. CPC G06F 17/30477; G06F 17/30011; G06F 17/30554

(57) ABSTRACT

Various embodiments of systems and methods for tag based searching in data analytics are described herein. In an aspect, the method includes receiving a request for perforating search on one or more data containers. Based upon the request, a search keyword is identified to perform search on the one or more data containers. Determine whether one or more tags associated with the one or more data containers matches the search keyword. When the one or more tags matches the search keyword, data containers of the one or more data containers whose one or more tags matched the search keyword is identified. The identified data containers are displayed as a search result.

### BACKGROUND

There are several known techniques to perform data analytics and search operations on textual data. However, in the world of smart devices, data are often stored in a non-textual format such as audio, video, image, etc. It is difficult to perform analytics and/or search operations on non-textual data, e.g., computer aided design (CAD) files describing two-dimensional (2D) or three dimensional (3D) designs, audio file, video file, etc. Performing search or analytics disregarding non-textual data might lead to inaccurate results. Further, converting the non-textual data into the textual data to perform analytics or search operation might be an arduous task.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram illustrating an exemplary tag based search environment for data analytics, according to an embodiment.

FIG. 2 illustrates a graphical user interface for associating tags to a file, according to an embodiment.

FIG. 3 illustrates an exemplarily index table including pointers to tagged files and tagged entities along with their corresponding tag(s), according to an embodiment.

FIG. 4 is a block diagram of a system for tag based search in a document management system (DMS), according to an embodiment.

FIG. 5 is a block diagram of an application management system including a tag service implementation and an attachment service implementation for an application, according to an embodiment.

FIG. 6 is a block diagram of a search engine coupled to a tag manager to perform search on a file repository including untagged textual data container, according to an embodiment.

FIG. 7 is a flowchart illustrating a process of performing tag based search, according to an embodiment.

FIG. 8 is a block diagram illustrating an exemplary computer system, according to an embodiment.

### DESCRIPTION

Embodiments of techniques for tag-based searching are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

“Device” refers to a logical and/or a physical unit adapted for a specific purpose. For example, a device may be at least one of a mechanical and/or an electronic unit. Device encompasses, but is not limited to, a communication device, a computing device, a handheld device, and a mobile device such as an enterprise digital assistant (EDA), a personal digital assistant (PDA), a tablet computer, a smartphone, a smartwatch, and the like. A device can perform one or more tasks. A device may include computing system comprising electronics (e.g., sensors) and software. A device may be uniquely identifiable through its computing system. A device can access internet services such as World Wide Web (www) or electronic mails (E-mails), and exchange information with another device or a server by using wired or wireless communication technologies, such as Bluetooth, Wi-Fi, Universal Serial Bus (USB), infrared and the like.

“Textual data” refers to written, printed, or electronically published symbols comprising alphabets, numerals, special graphical symbols and the like. The textual data may be composed on a device. The textual data may be in a tabular format, a text file format, a document format, etc. Textual data can be easily interpreted, analyzed, and searched.

“Non-Textual data” refers to data in a non-text format such as an audio data, a video data, an image data, etc. Non-textual data can be quickly and efficiently composed, e.g., chart, diagram, figure, video file, power point presentation (.ppt), flowchart, graph, audio file, etc., on any smart device.

“Entity” or “object” refers to a “thing of interest” for which data (textual data and/or non-textual data) is to be collected/analyzed. For example, an entity may be a customer, an employee, a sales quote, a sales order (SO), a purchase order (PO), an account name or number, a contact, a car, etc. The entity comprises one or more attributes, properties, or features that characterize the entity. For example, the entity “car” may comprise attributes such as “engine,” “color,” “model,” etc. The entity may include an attachment (e.g., a document or a file) having description related to the entity in the textual and/or the non-textual format.

“Tag” refers to a keyword, a term, or a label which is assigned to or attached to an entity or a document having the textual and/or the non-textual data. The tag may be a kind of metadata which helps describe the entity or the document. The tag acts like an add-on or the label and does not alter the original entity or the document. The tag may be assigned by a user composing the entity and/or the document. The tagged entity or the tagged document may be retrieved or searched using its tag(s). The tag may also indicate information about its resource such as whether the tag is associated with an image, audio, video, or text document, etc. The entity or the document may be tagged using various tagging techniques known in the art.

“Classification” refers to grouping the entities, documents, and/or files based on their tags. For example, documents having the same tag may be grouped together under same group or class. The document may be filtered based on their tags. In various aspects, the tags itself may also be classified. The tags may be classified dynamically, at runtime, e.g., based upon the search criteria or search pattern of a user. For example, if a user performs search for TAG1 and within the same search, the user also searches for TAG2 then the tags (TAG1 and TAG2) may be dynamically categorized or grouped together. The tags may also be classified based upon their resource such as the tags belonging to an image file may be classified or grouped together under one class and the tags belonging to the audio files may be classified together under another class, etc.

“Document information record” (DIR) refers to a master record which stores information or metadata of a file or a document. For example, the DIR may store information such as a document's storage_location, name, version, last_modifie_date, author_name, etc. The document may be searched based upon its metadata information through the DIR.

“Product lifecycle management” (PLM) refers to a software application which manages processes or steps of lifecycle of an entity or a product. For example, the PLM may manage the lifecycle of a product from inception, through engineering design and manufacture, to service and disposal of the product. The PLM provides a product information “warehouse” for organizations. The PLM provides faster time-to-market, increased productivity, design efficiency, increased product quality, lower cost of new product, insight into business processes, and better reporting and analytics, etc. The PLM includes a search feature to enable perform search related to any keyword provided by the user. The search may be performed based upon the attributes or metadata of the entity (e.g., the description, identifier (ID), etc.), the metadata or container of the document related to the entity, the entity classification, and tags associated with the entity or the document, etc.

“Tag Manager” refers to a component for managing tags. The tag manager may be a part of software applications such as the PLM, customer relationship management (CRM), human resource management system (FIRMS), NetWeaver®, etc., or it may be a separate and an independent unit communicatively coupled to the software applications. The tag manager may: (i) enable associating tags to the documents and/or entities; (ii) provide auto-tagging or auto-tag suggestion facility based upon a context or container of the document or the entity to be tagged; (iii) provide search results (i.e., the entities and/or documents) based upon the search keyword or tag provided by the user; (iv) determine and render other tag(s) related to the search tag or keyword; (v) dynamically prioritize or assigns priority index (ranks) to the tags based upon one or more parameters, including, but not limited to, prior user's inputs or prior selection of tag, number of times the tag is previously used or selected, number of times the tag is previously shown in search results, etc.; (vi) display the tags based upon their priority index, e.g., in auto-tagging; (vii) dynamically classify the tags based upon search pattern or criteria; etc.

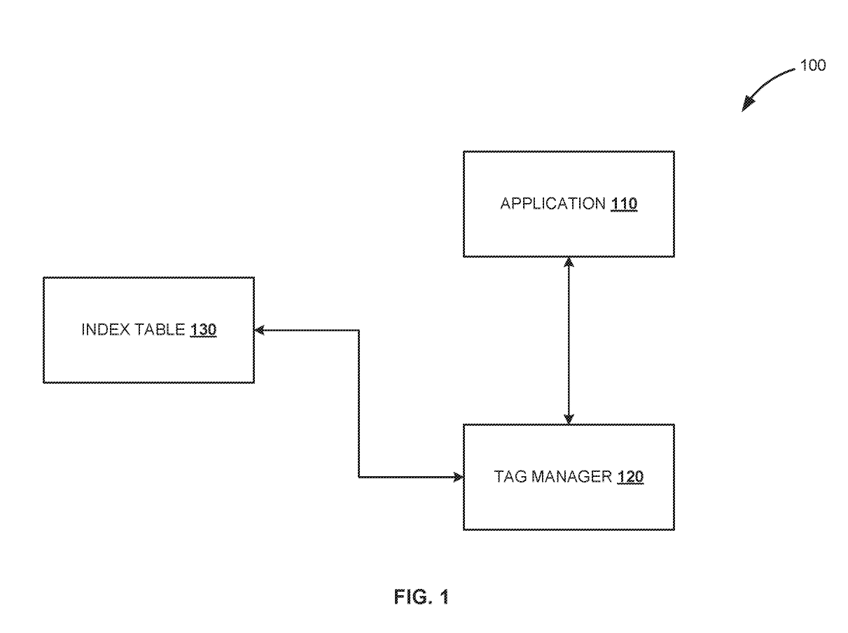

FIG. 1 is a block diagram illustrating exemplary tag based search environment 100 for data analytics, according to an embodiment. The tag based search environment 100 includes an application 110 having facility to tag data container and a tag manager 120 for managing tags of the data container. A data container may refer to a document or a file including one or more textual and/or non-textual data. In an embodiment, the data container may refer to an entity including one or more textual and/or non-textual data. When data container includes exclusively textual data, it may be referred to as “textual data container”. When data container includes at least some non-textual data, it may be referred to as “non-textual data container.” The application 110 includes a data container having textual and/or non-textual data such as text, audio, video, image, etc. The application 110 may be a software application such as Enterprise Resource Planning (ERP), product lifecycle management (PLM), customer relationship management (CRM), human resource management (HRM), document management system (DMS), etc., built on a computing platform such as NetWeaver®. The data container of the application 110 may be tagged. The tag manager 120 manages tags within the data container of the application 110. For example, the tag manager 120 enables associating tags to the data container, enables performing search related to the tags, and provides search results based upon the search criteria. In an embodiment, the tag manager 120 may be a part of the application 110. In one embodiment, the tag manager 120 may be a separate unit which is communicatively coupled to the application 110.

The tag manager 120 is communicatively coupled to index table 130 for performing tag based search. In an embodiment, the index table 130 may be a part of the application 110. The index table 130 stores reference(s) such as pointer(s) to the tagged data container (e.g., pointers or address to the files, the documents, and the entities) and their corresponding tag(s). When a search keyword (e.g., “TAG1”) is entered by the user through the application 110, the tag manager 120 refers to the index table 130 to determine if the search keyword matches any tag(s) associated with the data containers (i.e., the files, the documents, and the entities). When the keyword matches the tag associated with at least one of the data containers, the tag manager 120 identifies the corresponding data container and may display the data container as a search result. The search result points to the relevant data container (i.e., the document, the file, and/or the entity) whose tag matches the search keyword. In an embodiment, the tag manager 120 also determines related tag(s) associated with the searched data container and displays the related tags along with the search result. When the keyword does not match any of the tag(s) associated with the data containers, the tag manager 120 displays a notification, e.g., “no search result found.”

The non-textual data containers such as a Visio file, an image file, an audio file, and a video file, etc., may be arduous to be searched based upon their contents such as images, pictures, audio, and video data. The non-textual data containers, therefore, may be tagged and searched based upon their tags. The tags may be composed based upon the contents of the non-textual data container. For example, tags such as ‘generator,’ ‘power grid,’ and ‘water pump’ may be composed based upon the images of the ‘generator,’ ‘power grid,’ and ‘water pump’ included in an image file (e.g., file Z). Similarly, tags such as ‘walking’ and ‘hand in hand’ may be composed based upon a song ‘walking hand in hand . . . ’ included in an audio file. The search may be performed on the non-textual data containers based upon their tag(s). A graphical user interface (GUI) may be provided for performing search based on keyword provided by the user. When the user enters the search keyword, e.g., “power grid,” the tag manager refers to the index table to determine whether the search keyword matches any of the tag(s) associated with the non-textual data containers. When the search word (e.g., power grid) matches a tag associated with the image file Z. The image file Z is displayed as the search result. In an embodiment, the search result may also include other tags (i.e., related tags such as ‘generator’ and ‘water pump’) related to the image file Z.

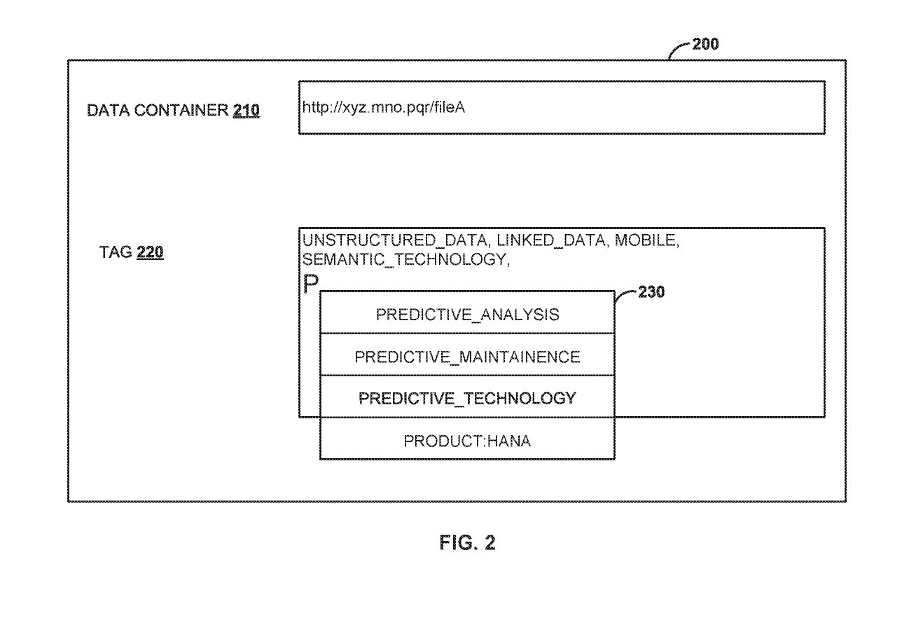

FIG. 2 illustrates a graphical user interface (GUI) 200 of application 110, for associating tag(s) to a data container related to the application. The GUI 200 includes a field “data container 210” for uploading the data container (i.e., a file or an entity) to be tagged. The user may “browse” and select the data container (e.g., the file) to be uploaded from a data container source (“http://xyz.mno.pqr/fileA”) or a data container repository. The data container source or repository may be a part of the application, may be on cloud, or may be a separate unit positioned outside the application, e.g., independent on-premise server. Once the file (e.g., “fileA”) is uploaded, the user may provide tag(s) to be associated with the file. The tag(s) may be provided through a tag field 220. For example, if the “fileA” is related to HAMA® predictive analysis, the tag may be provided as product: “HANA”, “unstructured_data,” “predictive_analysis,” “mobile,” “predictive_maintenance,” “semantic_technology,” “linked_data” etc. A tag may be provided or composed based upon the description and context of the file to be tagged (e.g., “fileA”) and the user's choice. In an embodiment, the tags for the non-textual data container may be composed based upon its non-textual contents. For example, as discussed, the tags ‘generator,’ ‘power grid,’ and ‘water pump’ are composed based upon the images of the ‘generator,’ ‘power grid,’ and ‘water pump’ included in the image file Z.

In an embodiment, an auto-tagging facility is provided by the tag manager 120. While composing or entering tag, pre-used or pre-defined tags may be proposed or suggested to the user based upon the container or context of the data container or file to be tagged. The tags (pre-used or pre-defined) may be stored in a tag repository (not shown). The tag manager may refer to the tag repository to determine the pre-used or pre-defined tags starting with an alphabet or character entered by the user. In an embodiment, the tag manager refers to the tag repository to determine the tags (pre-defined tags) to be proposed or suggested to the user based upon the context of the data container or file to be tagged and/or the initial letter of the tag composed by the user. The pre-used or pre-defined tags are proposed or suggested, e.g., through a menu (pop-up window) 230. The user can select the tag of their choice from the suggested tags or options displayed in the menu 230, or the user may compose a new tag. For example, if the user attempts to create a tag starting with the alphabet “P” the options or tags such as “predictive_analysis,” “predictive_maintenance,” and “predictive_technology” may be displayed in the menu 230. In an embodiment, the tags are proposed or displayed in the menu 230 based upon their rank or popularity index. In an embodiment, the rank may be an integer value. The rank may be calculated by the tag manager. In an embodiment, the rank is calculated dynamically based upon one or more parameters, including, but not limited to, user's prior input or selection of tags across different entities or documents, number of times the tags are used or selected across different entities or documents, number of times the tags are shown in search results, etc. The proposed tags are arranged or displayed in the menu 230 based upon their rank. For example, the tag having highest rank (popularity index) would be displayed as the top menu option in the menu 230. In an embodiment, when one or more tags have same rank, the one or more tags are arranged in the menu based upon their alphabetical order.

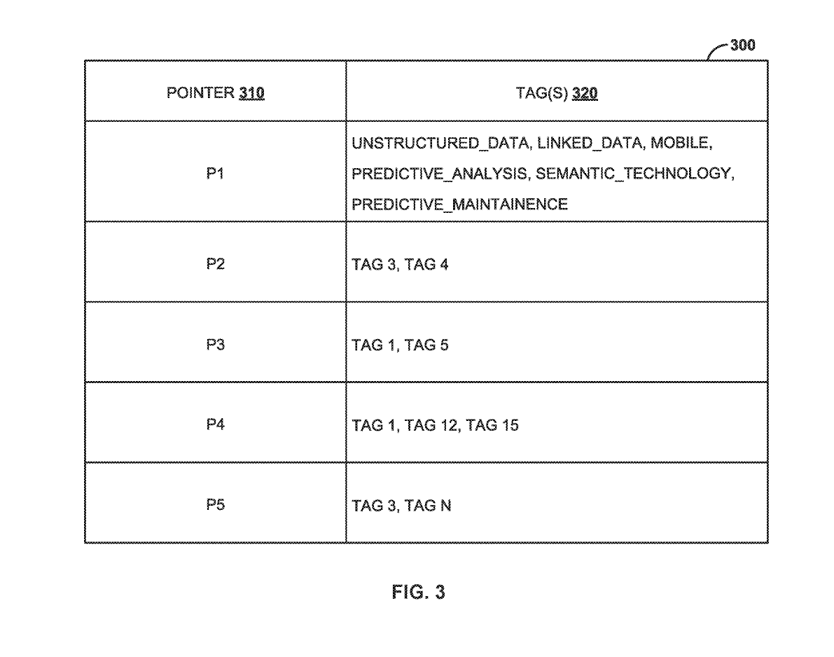

Once the tag is provided for the data container (e.g., file), the tag manager updates an index table (e.g., the index table 130 of FIG. 1), FIG. 3 illustrates an exemplarily index table 300. The index table 300 includes a pointer attribute 310 which defines pointers or address of various data container (e.g., entities and/or documents) that is tagged. For example, the pointer attribute 310 includes a pointer P1 that may point to the “fileA” (e.g., “http://xyz.mno.pqr/fileA”) and the pointers P2-P5 that may point to the respective entities E2-E5. The pointer typically refer to an address of the data container. The index table 300 also includes a tag(s) attribute 320 which defines one or more tags associated with the corresponding pointer (e.g., corresponding data container). For example, the tag(s) attribute 320 includes the tags “unstructured_data,” “linked_data,” “mobile,” “predictive_analysis,” “sernantic_technology,” and “predictive_maintenance” corresponding to the pointer P1 or the fileA (location: http://xyz.mno.pqr/fileA). Similarly, the tag(s) attribute 320 includes tags {tag3, tag4}, {tag1, tag5}, {tag1, tag12, tag15}, and {tag3, tagN} corresponding to the pointers P2, P3, P4, and P5, accordingly.

The tagged “data container” (files or entities) may be text, audio, video, or an image file. The tagged file or entities may be searched based upon their tag(s). A graphical user interface (GUI) may be provided for performing search based on search tag or keyword provided by the user. When the user enters the search keyword, e.g., “TAG3,” the tag manager refers to the index table, e.g., the index table 300 of FIG. 3. The tag manager determines whether the search word matches any of the tag(s) associated with the pointers of the index table 300. When the search word (e.g., TAG3) matches a tag associated with one or more pointers, e.g., pointers P2 and P5, of the index table 300, the tag manager determines the entities or files associated with the pointers P2 and P5. For example, the tag manager determines the entities E2 and E5 associated with the pointers P2 and P5, respectively. The entities {E2 and E5} are displayed as the search result. In an embodiment, the search result may also include other tags (i.e., related tags) related to the entities E2 and E5, respectively. For example, the search result may be displayed as:

### Search Result:

| Entity/document | Related tag(s) |
|---|---|
| E2 | TAG4 |
| E5 | TAGN |

The search result, may include different entities and/or files having the search keyword or tag. The search may be broad and not restricted to a specific entity. In an embodiment, the user may further drill down or navigate, in a discrete fashion, through the related tags displayed in the search result. For example, the user may further navigate to the related TAG4 of the entity E2 or TAGN of the entity E5 to determine its relation with the searched TAGS and its usefulness in context of the current search. In an embodiment, the tag manager dynamically calculates the rank or popularity index of the tag, e.g., based upon the user navigation. For example, if the user selects the related TAG4, its popularity index may be incremented by 1. When the search word does not match any of the tag(s) associated with the data container, the tag manager may display a notification, e.g., “no search result found.”

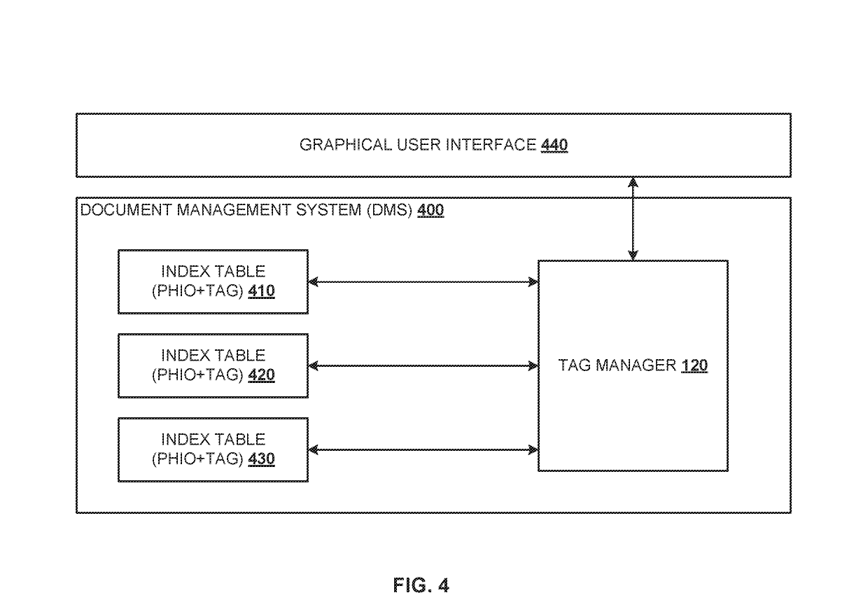

FIG. 4 illustrates tag based search in a document management system (DMS) 400, according to one embodiment. The DMS 400 may be responsible for managing; documents and files associated with entities. The documents and files may be tagged. The tag related information of the documents and file is maintained in one or more index tables, e.g., index tables 410, 420, and 430. The index tables 410-430 may be part of the DMS 400 or may be separate units independent of the DMS 400. The index tables 410-430 may include physical index of object (PHIO). The PHIO is a pointer to the object. In case of the DMS 400, the object refers to the documents and/or files managed by the DMS 400. In an embodiment, the documents, files and/or attachments may be stored in a repository outside the DMS 400 (e.g., on a database server). The index tables 410-430 may include pointers to the documents, files and/or attachments stored in the repository, and tag(s) corresponding to the pointers. The user may enter a search keyword or search term through GUI 440. In an embodiment, the GUI 440 may be a part of the DMS 400. A tag manager, e.g., within the DMS 400, may receive the search keyword. The tag manager reads the index tables 410-430 to determine if any of the index tables 410-430 include tag(s) matching the search keyword. The index tables 410-430 may include different information related to the same pointer or PHIO (e.g., related to the same file, document, or attachment). Once it is determined that at least one of the index tables 410-430 includes tag(s) matching the search keyword, the tag manager identifies the pointers having tag(s) matching the search keyword. The tag manager may determine and retrieve the file, document, or attachment based on the identified pointers. The determined file, document, or attachment may be displayed as the search result. In an embodiment, other tags related to the determined documents, files, and/or attachments may be also displayed in the search result. In an embodiment, the non-textual data containers and/or the textual data containers within the search result may be ranked or prioritized based upon various parameters and using various techniques known in the art.

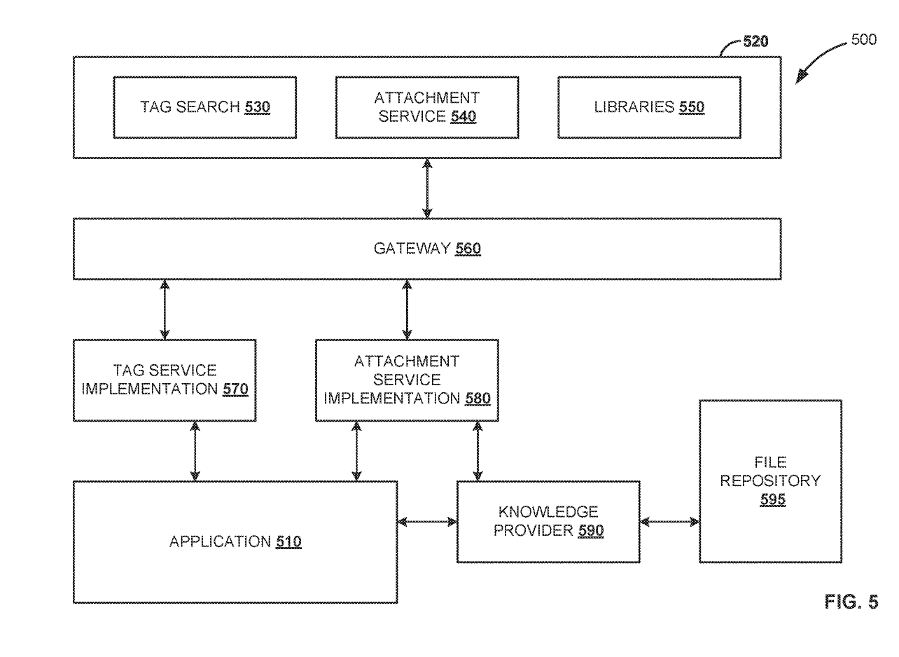

FIG. 5 illustrates application management system 500 to manage attachment and tag feature in application 510, according to one embodiment. The application 510 may be a software application or product such as DMS, HRMS, CRM, etc. Some applications such as DMS applications include tags related to attachments (file/document). Some applications such as CRM, PLM, etc., include tags related to entities and/or attachments. The system 500 includes a GUI 520 for enabling users to manage tags and attachments related to the application 510. The GUI 520 includes component ‘tag search’ 530 to enable users to search tag(s) associated with the application 510; component ‘attachment service’ 540 to enable users to attach files or documents for any entity of the application 510; and component libraries' 550 to store information for rendering or loading the graphical user interfaces (UIs) such as the GUI 520 itself. The GUI 520 may be coupled to ‘tag service implementation’ 570 and ‘attachment service implementation’ 580 through gateway 560 (e.g., SAP® NetWeaver® gateway). The gateway 560 identifies a requested service (e.g., requested through the tag search 530 or the attachment service 540) and delegates the requested service to an appropriate component (the tag service implementation 570 or the attachment service implementation 580). In an embodiment, the tag service implementation 570 and the attachment service implementation 580 may be a part of the application 510. In one embodiment, the tag service implementation 570 and the attachment service implementation 580 may be a separate unit or units positioned outside the application 510. The tag service implementation 570 may be part of or communicate with a tag manager (not illustrated in FIG. 5, e.g., the tag manager 120 of FIG. 1) to manage or perform tag based search as explained in previous paragraphs. The tag manager (e.g., the tag manager 120 of FIG. 1) may be a part of the application 510 or may be a separate unit positioned outside the application 510. The attachment service implementation 580 helps in managing attachments (file, documents, etc.) related to the entities of the application 510.

The attachment service implementation 580 is communicatively coupled to the application 510 and knowledge provider 590. The attachments or files related to the application 510 may be managed by the attachment service implementation 580. The attachment service implementation 580 enables storing attachments or files in file repository 595. The file repository 595 may be on cloud or on premise. The attachment service implementation 580 transfers or stores the attachment or files into the file repository 595 through the knowledge provider 590. The attachment or files may be read, stored, or retrieved from the file repository 595 through the knowledge provider 590. The knowledge provider 590 includes document management module to manage documents or files and their relationships, container management service to store file references, their metadata or categories, and their locations, and an index management service to enable performing search using, e.g., the index tables.

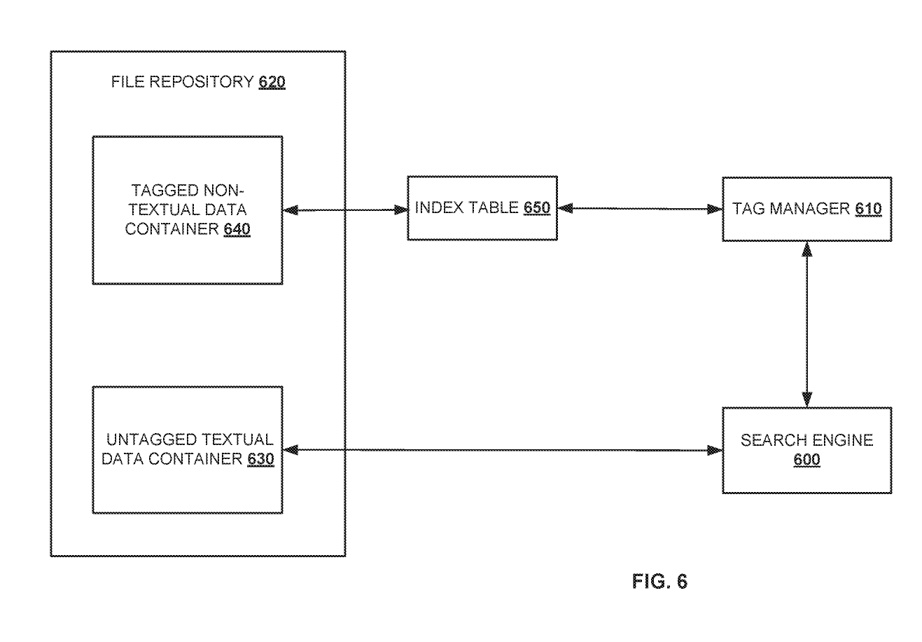

In an embodiment, the tag based search of non-textual data container may be merged with a text-based search technique of textual data container. FIG. 6 illustrates search engine 600 communicatively coupled to tag manager 610 for performing search on file repository 620 including untamed textual data container, according to an embodiment. The file repository 620 includes untagged textual data container 630 and tagged non-textual data container 640. In an embodiment, the search engine 600 determines whether the textual data container is tagged. When the textual data container is tagged, the search is performed by the tag manager 610 on the tagged textual data container and the non-textual data container 640, as explained in previous paragraphs, using the index table 650. When the textual data container is untagged (e.g., the untagged textual data container 630), the search engine 600 performs text search on the untamed textual data container 630. For example, the search engine 600 searches the untagged textual data container 630 to determine whether the search keyword matches any word within the untagged textual data container 630. When a word within the textual data container 630 matches the search keyword, the textual data container 630 is displayed along with the search result generated by the tag manager 610 for tag-based search performed on the tagged non-textual data container 640. When the word(s) within the textual data container 630 does not match the search keyword, the tag manager 610 is informed and the search result generated by the tag manager 610 is displayed. In case the search keyword does not match any tag of the tagged non-textual data container 640 and any word within the untagged textual data container 630, a notification (e.g., no search result found) is displayed by the search engine 600. In an embodiment, the tag manager may be a part of the search engine 600.

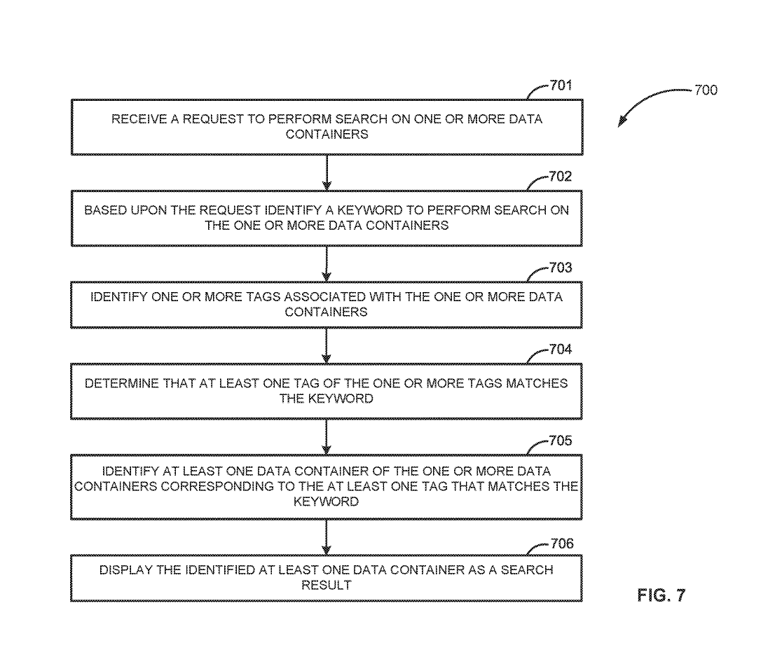

FIG. 7 is a flowchart illustrating process 700 to perform tag based search, according to an embodiment. At 701, a request, e.g., sent by a user to perform search on one or more data containers (e.g., entities and/or files including textual and/or non-textual data) is received by a tag manager (e.g., the tag manager 120 of FIG. 1). At 702, based upon the request, a keyword (e.g., a search keyword) is identified to perform search on the one or more data containers. At 703, one or more tags associated with the one or more data containers are identified. At 704, it is determined that at least one of the one or more tags matches the keyword. At 705, at least one data container of the one or more data containers corresponding to the at least one of the one or more tags that matches the keyword is identified. At 706, the identified at least one data container is displayed as a search result. In an embodiment, the search result also includes one or more other tags related to the identified at least one data container. When the one or more tags of the one or more data containers does not match the keyword, a notification (e.g., “no search result found”) is displayed.

Embodiments enable to perform search or data analytics on textual as well as non-textual data containers including, but not limited to, audio file, video file, and image file. Data containers (documents or entities including the data (textual and non-textual)) may be tagged and searched. Any tag may be composed, e.g., based upon the user's choice and convenience. The data containers (e.g., the audio/video file) can be tagged with description and can be searched based upon the tagged description. The search technique e.g., the search technique within the PLM) is enhanced and the search is not only restricted to the entity metadata and/or its file metadata. The search technique is flexible and the search can be performed based upon the tags associated with the data containers (entity and its file). The search may be performed across various different entities based upon the search keyword or tag and therefore, is not restricted to a specific entity. For example, the files associated with different entities can be searched, outside specific entity context, based upon the search keyword, therefore, the search is broad and non-restrictive to any entity.

The data containers can be flexibly classified and/or indexed based upon the associated tag(s). Therefore, there is no requirement of creating, verifying, and associating a class (including group of attributes) to classify the data container or entity, e.g., within the PLM. The entity can be quickly and easily classified (grouped) by associating tag(s) to the entity. Further, the classification may not be restricted to the entity level, rather, the files may also be classified, e.g., by associating tag(s) to the file. The tags may be indexed or ranked dynamically based upon one or more parameters, including, but not limited to, prior user's inputs or selection of tag, number of times the tag is previously used or selected, number of times the tag is previously displayed in the search results, etc. The ranking or indexing helps in prioritizing tags while displaying auto-suggestion for inputting tags. In auto-tagging, the tags are proposed or suggested based upon the context. For example, the tags may be proposed based on the context of the file or the entity which is tagged. Moreover, the tagging and searching can be performed in various languages, i.e., the tags can be composed in different languages and the search can be performed in the corresponding language.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java. C++, or other object-oriented programming language and development tools. Another embodiment may be implemented in hard-wired circuitry in place of, or in combination with machine readable software instructions.

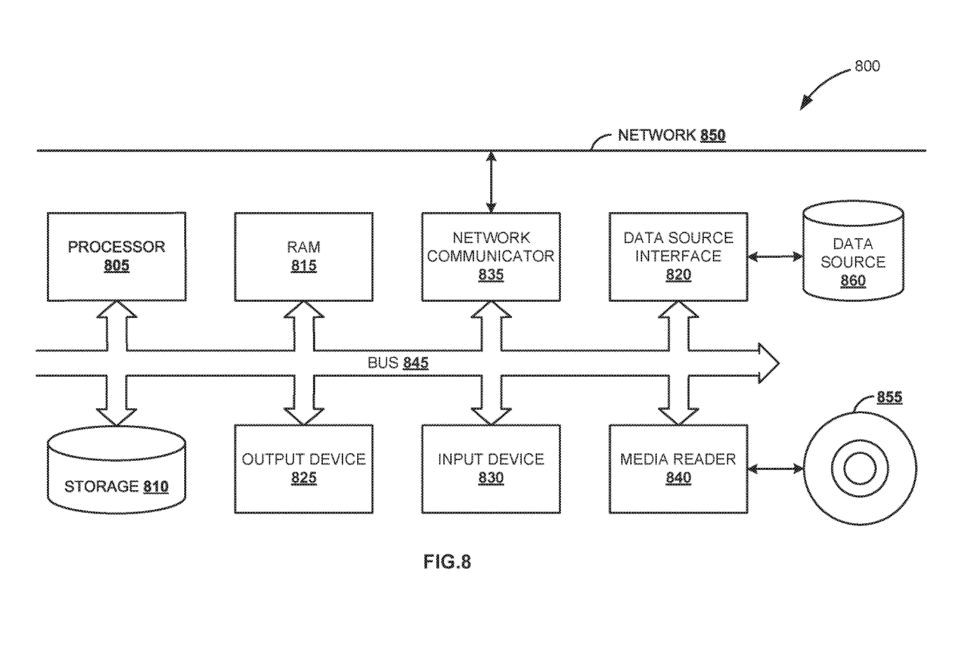

FIG. 8 is a block diagram of an exemplary computer system 800. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments; the RAM 815 can have sufficient storage capacity to store much of the data required for processing in the RAM 815 instead of in the storage 810. In some embodiments, the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. The output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

1. A non-transitory computer readable storage medium storing instructions, which when executed by a computer causes the computer to: receive a search request including a keyword to perform search on a plurality of document information records (DIRs), the plurality of DIRs associated with a plurality of non-textual data containers;
identify a plurality of tags associated with each of the plurality of DIRs;
determine a tag from the plurality of tags that matches the keyword;
identify a DIR from the plurality of DIRs corresponding to the tag that matches the keyword;
identify a non-textual data container from the plurality of non-textual data containers associated with the identified DIR; and
display the identified non-textual-data container and the identified DIR as a search result.

2. The computer readable medium of claim 1 further comprising instructions which when executed by the computer causes the computer to:
upon determining that the plurality of tags associated with the plurality of DIRs does not match the keyword, display a notification.

3. The computer readable medium of claim 1 further comprising instructions which when executed by the computer causes the computer to:
determine one or more other tags related to the tag that matches the keyword; and
display the determined one or more other tags in the search result.

4. The computer readable medium of claim 1, wherein the plurality of tags are associated with a DIR of a non-textual data container when composing the non-textual data container.

5. The computer readable medium of claim 4 further comprising instructions which when executed by the computer causes the computer to:
identify a request to compose a tag for the non-textual data container; and
based upon the identified request, perform operations comprising:
identifying an initial letter of the tag to be composed;
identifying a context for which the tag is composed;
based upon the identified context and the identified initial letter, searching a tag repository to determine one or more tags starting with the identified initial letter in the identified context; and
displaying the determined one or more tags starting with the identified initial letter in the identified context in a menu.

6. The computer readable medium of claim 5, wherein the one or more tags displayed in the menu are arranged in the menu based upon their rank.

7. The computer readable medium of claim 6, wherein a rank of a tag of the one or more tags is determined based upon at least one of a number of times the tag is previously selected and a number of times the tag is previously displayed in the search result.

8. The computer readable medium of claim 6, wherein when the one or more tags have same rank, the one or more tags are arranged in the menu based upon their alphabetical order.

9. The computer readable medium of claim 1, wherein a non-textual data container of the plurality of non-textual data containers includes at least one of an image, an audio, and a video.

10. A computer-implemented method for tag based search, the method comprising:
receiving a search request including a keyword to perform search on a plurality of document information records (DIRs), the plurality of DIRs associated with a plurality of non-textual data containers;
identifying a plurality of tags associated with each of the plurality of DIRs;
determining a tag from the plurality of tags that matches the keyword;
identifying a DIR from the plurality of DIRs corresponding to the tag that matches the keyword;
identifying a non-textual data container from the plurality of non-textual data containers associated with the identified DIR; and
displaying the identified non-textual-data container and the identified DIR as a search result.

11. The computer-implemented method of claim 10 further comprising:
upon determining the plurality of tags associated with the plurality of DIRs does not match the keyword, displaying a notification.

12. The computer-implemented method of claim 10 further comprising:
determining one or more other tags related to the tag that matches the keyword; and
displaying the one or more other tags in the search result.

13. The computer-implemented method of claim 10 further comprising:
identifying a request to compose a tag for a non-textual data container; and
based upon the identified request, performing operations comprising:
identifying an initial letter of the tag to be composed by a user;
identifying a context for which the tag is composed by the user;
based upon the identified context and the identified initial letter, searching a tag repository to determine one or more tags starting with the identified initial letter in the identified context; and
displaying the determined one or more tags starting with the identified initial letter in the identified context in a menu.

14. The computer-implemented method of claim 13, wherein the one or more tags displayed in the menu are arranged in the menu based upon their respective rank and wherein a rank of a tag of the one or more tags is determined based upon at least one of a number of times the tag is previously selected and a number of times the tag is previously displayed in the search result.

15. A computer system for tag based search, the system comprising:
at least one memory to store executable instructions; and
at least one processor communicatively coupled to the at least one memory, the at least one processor configured to execute the executable instructions to:
receive a search request including a keyword to perform search on a plurality of document information records (DIRs), the plurality of DIRs associated with a plurality of non-textual data containers;
identify a plurality of tags associated with each of the plurality of DIRs;
determine a tag from the plurality of tags that matches the keyword;
identify a DIR from the plurality of DIRs corresponding to the tag that matches the keyword;
identify a non-textual data container from the plurality of non-textual data containers associated with the identified DIR; and
display the identified non-textual-data container and the identified DIR as a search result.

16. The system of claim 15, wherein the processor is further configured to execute the executable instructions to:
upon determining the plurality of tags associated with the plurality of DIRs does not match the keyword, displaying a notification.

17. The system of claim 15, wherein the processor is further configured to execute the executable instructions to:
determine one or more other tags related to the tag that matches the keyword; and
display the determined one or more other tags in the search result.

18. The system of claim 15, wherein the processor is further configured to execute the executable instructions to:
identify a request to compose a tag for the non-textual data container; and
based upon the identified request, perform operations comprising:
identifying an initial letter of the tag to be composed by a user;
identifying a context for which the tag is composed by the user;
based upon the identified context and the identified initial letter, searching a tag repository to determine one or more tags starting with the identified initial letter in the identified context; and
displaying the determined one or more tags starting with the identified initial letter in the identified context in a menu.

19. (canceled)

20. The system of claim 18, wherein the one or more tags displayed in the menu are arranged in the menu based upon their respective rank and wherein a rank of a tag of the one or more tags is determined based upon at least one of a number of times the tag is previously selected and a number of times the tag is previously displayed in the search result.

21. The system of claim 18, wherein the processor is further configured to execute the executable instructions to:
identify a plurality of objects associated with the plurality of non-textual data containers;
determine objects whose non-textual data containers have at least one tag in common; and
assign a class or a group to the determined objects.
